(19) United States
(12) Patent Application Publication
(10) Pub. No.: US 2016/0234225 A1
(43) Pub. Date: Aug. 11, 2016

(54) METHOD AND SYSTEM FOR MULTILEVEL SECURE WEB-BASED DIGITAL INFORMATION STORAGE

(71) Applicant: Robert Lane, Towaco, NJ (US)

(72) Inventor: Robert Lane, Towaco, NJ (US)

(21) Appl. No.: 15/017,199

(22) Filed: Feb. 5, 2016

Related U.S. Application Data
(60) Provisional application No. 62/112,477, filed on Feb. 5, 2015.

(51) Int. Cl. H04L 29/06

(52) U.S. Cl. CPC H04L 63/105; H04L 63/083; H04L 63/102; H04L 67/42

(57) ABSTRACT

The invention broadly comprises a system and method for a secure web-based digital storage means comprising multiple user selectable security levels, each security level requiring a unique authentication means for access, said storage means providing for the highly secure storage of digital information.

This Application claims priority to Provisional U.S. Patent Application Ser. No. 62/112,477 filed on Feb. 5, 2015.

### FIELD OF THE INVENTION

The invention broadly comprises a system and method for a secure web-based digital storage means comprising multiple user selectable security levels, each security level requiring a unique authentication means for access, said storage means providing for the highly secure storage of digital information.

### BACKGROUND

Many websites used for purchasing goods and conducting confidential and/or financial transactions, as well as social networking and many other websites require user registration and subsequent authentication of the user's identity before allowing access to the website's features and/or content. Secure access to computer systems and computer networks have been traditionally protected with a username and password pair. The traditional username and password pair form of computer and network protection has become prevalent on countless websites internet users encounter every day. Thus, an individual is required to remember multiple, and often times too numerous to simply remember, username and password pairs for the multitude of websites an individual utilizes.

Unless an individual utilizes the exact same username and password pair (which may be impossible due to requirements of individual website's security requirements and is inherently unsafe), an individual will have too many username and password pairs to remember. With memorization impracticable, individuals often maintain an unsecured physical list and/or electronic database of their username and password pairs. If a username and password pair is unprotected, an individual's accounts as well as the information associated therewith, can be easily compromised. Recently, a large number of nefarious individuals and unethical entities have emerged that are dedicated solely to obtaining an individual's confidential information for unauthorized or criminal activities. Moreover, due to the large number of username and password pairs an individual is required to remember, individuals often choose simple, obvious and non-secure usernames and password pairs. This common practice leaves an individual's account and associated information susceptible to compromise.

Moreover, it is common practice for an individual to use charge cards for financial transactions on the internet. The so-called e-commerce market has exploded in recent years and for many people, comprises a large percentage of their yearly purchases. Due to this fact, many people wish to have the information associated with their various charge cards available at all times. In many circumstances, people store charge card information in unsecured physical lists and/or electronic databases that can lead to theft of this highly sensitive information. Another common practice is to have a web browser save and/or “remember” charge card information so that charge card information can be automatically populated by the web browser. This practice is high unsecure and allows any person utilizing the computer and web browser to have ready access to the saved charge card information.

Means of secure digital storage are known in the art. Importantly, unlike the disclosed embodiments, the secure digital storage means currently known offer only a single level of secure storage for an individual's sensitive information and/or files. Currently disclosed secure digital storage means allow access to an individual's stored information and/or files normally through the use of a single authentication means, most commonly a single username and password pair. Thus, if the individual's username and password pair for currently known secure digital storage means is compromised, the proverbial “keys to the kingdom” are compromised, and access to all of the individual's information and/or files stored in the digital storage means is available.

In addition, currently known secure digital storage means require either the installation of software and/or browser extensions, or require the individual to login into a separate website in order to access the user's stored username and password pairs and/or other information. These current limitations limit the functionality of currently known secure digital storage. An individual, due to various reasons, does not always want to install software onto certain electronic devices, but is still in need of his or her sensitive information stored on a secure digital storage means. In addition, it is not desirous, both for the website requiring a username and password pair for access, and the individual desiring the access, for that individual to be redirected to a separate webpage in order to access his or her sensitive information that he or she wants to enter into the currently viewed website.

As a result, there currently exists a need for a highly secure web-based digital storage means that provides for multi-level security, each security level requiring a unique authentication means. There is also currently a need for a highly secure web-based digital storage means which is accessible directly from a currently viewed website without the need for website redirection and without the use of associated software, mobile applications and/or browser extensions.

Secure digital storage means are known. For example, U.S. Pat. No. 6,356,941 discloses “a system for secure data storage, exchange and/or sharing through a protected central storage facility, containing at least one “network vault” to which access is controlled through a single data access channel. The network vault is similar to a physical safe, in that substantially any type of information can be stored in the network vault, and in that the user need only place the information inside the network vault for the information to be secured. Thus, the system of the present invention combines the flexibility of data storage and retrieval through a network, with the security of controlled access for data storage and retrieval at a fixed physical location.”

In another example, U.S. Patent Application 2011/0047606 A1 discloses “a system and method for managing a plurality of a user's authentication elements. In a preferred embodiment a user initiates a webpage browser session at a user website access device and activates a password manager program. The user's identity is authenticated to an authentication server and allowed to access a secure database comprising a plurality of website authentication elements. Thereafter, the user accesses a first secure website and the program determines the presence of a user authentication data field. When a user authentication data field is present the program instructs the authentication server to automatically transmit at least one of the authentication elements specific to the authentication data field of the first secure website to authenticate the user to the first website.”

U.S. Patent Application 2010/0017616 A1 discloses “Systems and methods for securely managing Internet user passwords are presented herein. A formation component can enable a user to create a master account on a web server, the master account comprising a master username and password. An access component can enable the user to access a plurality of password protected websites from a web browser or non-browser software application resident on the user's computing device when the user logs into the master account by entering the valid master username and password. A selection component can log the user into a web site of the plurality of password protected web sites when the user selects a hyperlink associated with the website, selects a linked image associated with the website, or selects the website from a pulldown list contained in a toolbar of a web browser. A display component can open a web browser or tab associated with the web site.”

In yet another example, located at https://keepersecurity.com/en_US/learnmore, it is disclosed as a “password manager and digital vault” which operates through the use of software that must be installed on a user's computer, smartphone, table or other electronic device.”

In another attempt to create a secure password manager and digital vault, located at http://www.trendmicro.com/us/home/products/software/password-manager/, software for use on a WINDOWS® or APPLE® based computer is disclosed.”

In another example located at https://lastpass.com/how-it-works, a software and browser extension based password manager and digital vault is disclosed.”

None of the foregoing examples, alone or in combination, disclose the salient aspects of the claimed features. Thus, there remains an unmet need for a highly secure web-based digital storage means that provides for multi-level security, each security level requiring a unique authentication means, said secure digital storage means capable of being accessible directly from a currently viewed website without the need for website redirection and without the use of associated software, mobile applications and/or browser extensions.

### SUMMARY

The invention broadly comprises a system and method for a highly secure web-based digital storage means that provides for multiple security levels for the storage of, and access to, digital information stored in a secure offsite webserver/database. Embodiments allow a user to assign a particular security level to specific digital information it wishes to securely store on the offsite webserver/database. In order to access the digital information stored on a particular security level, a unique authentication means is necessary. The same multiple security level protection can also be assigned to digital communications to create a secure digital communications means. In certain embodiments said secure web-based digital storage means is configured such that it is directly accessible from a currently viewed website without the need for website redirection and without the use of associated software, mobile applications and/or browser extensions.

Embodiments disclosed herein have the following advantages over other currently available digital storage means. First, due to the multiple levels of secure storage, embodiments provide for a much higher level of security than existing secure digital storage means. Existing digital storage means are protected by a single authentication method. Embodiments disclosed herein allow digitally stored information to be protected by multiple unique authentication methods. Secondly, embodiments provide users with the ability to send and receive secure communications by assigning each communication a security level, thereby allowing for highly secure digital communications.

One skilled in the art will appreciate that the system and method disclosed herein can be modified slightly to yield similar results in various circumstances and situations. One of skill in the relevant art will appreciate the novel and salient components of the system and method disclosed herein.

### BRIEF DESCRIPTION OF THE DRAWINGS

FIG. 1 is a diagrammatic representation of the multilevel security component, in accordance with an embodiment of the invention.

FIG. 2 is a diagrammatic representation of the dashboard component, in accordance with an embodiment of the intention.

### DETAILED DESCRIPTION

One skilled in the relevant art will recognize that the instant disclosers can be undertaken without one or more of the specific details, or with other methods, components, materials, etc. to obtain similar results and/or results in specific scenarios. In other instances, well-known structures, materials or operations are not shown or described in detail to avoid obscuring certain aspects.

Reference throughout this Application to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout this Application are not necessarily all referring to the same embodiment. Furthermore, the particular features, structures, or characteristics may be combined in any suitable manner in one or more embodiments.

For clarity of disclosure, and not by way of limitation, the detailed description of embodiments presented herein is divided into the following subsections that describe or illustrate certain features, embodiments or applications.

### Definitions

“Digital Information” shall mean any form of digital information known in the art, including, but not limited to all known file types as well as text information such as username and password pairs.

“Authentications Means” shall mean any digital authentications means known in the art, including, but not limited to username and password pairs, fingerprint identification, crypto key, images, encryption, secure sockets layer (SSL) protocol or any combination thereof.

### The System and Method

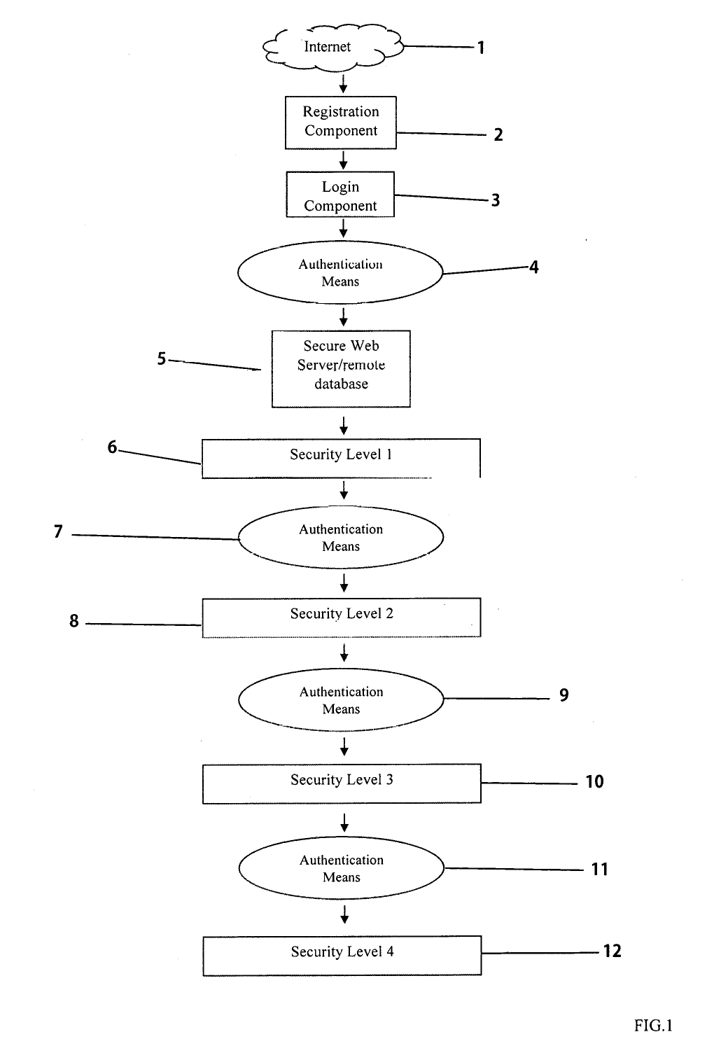

With reference now to the Figures, and more specifically FIG. 1. FIG. 1 is a diagrammatic representation of the multilevel security component of the present invention. A web-based (1) registration component (2) enables a user to create a master account on a secure webserver/remote database (5), and provides the user with a master account login comprising one authentication means and the information necessary to satisfy said authentication means. A web-based login component (3) enables a user to securely access a first security level (6) by entering the information necessary to satisfy the master account login authentication means (4). Once a user gains access to level one (6), the user can access all digital information stored on level one, if any, but cannot access any higher security levels (e.g. security levels two (8) and three (10) and so forth) without entering the information necessary to satisfy the additional authentication means associated with each other security level (7, 9 and 11). If a user wishes to access the level two security level (8), the user must enter the information required to satisfy the additional authentication means associated with level two (7). Once access to security level two (8) is gained by the user, the user will have access to all digital information stored on levels one (6) and two (8), if any. If a user wishes to access security level three (10), the user must enter the information required to satisfy the additional authentication means associated with security level three (9). Once access to security level three (10) is gained by the user, the user will have access to all digital information stored on levels one (6), two (8) and three (10). The foregoing manner of successive multilevel security can be utilized to create as many distinct security levels as a user desires.

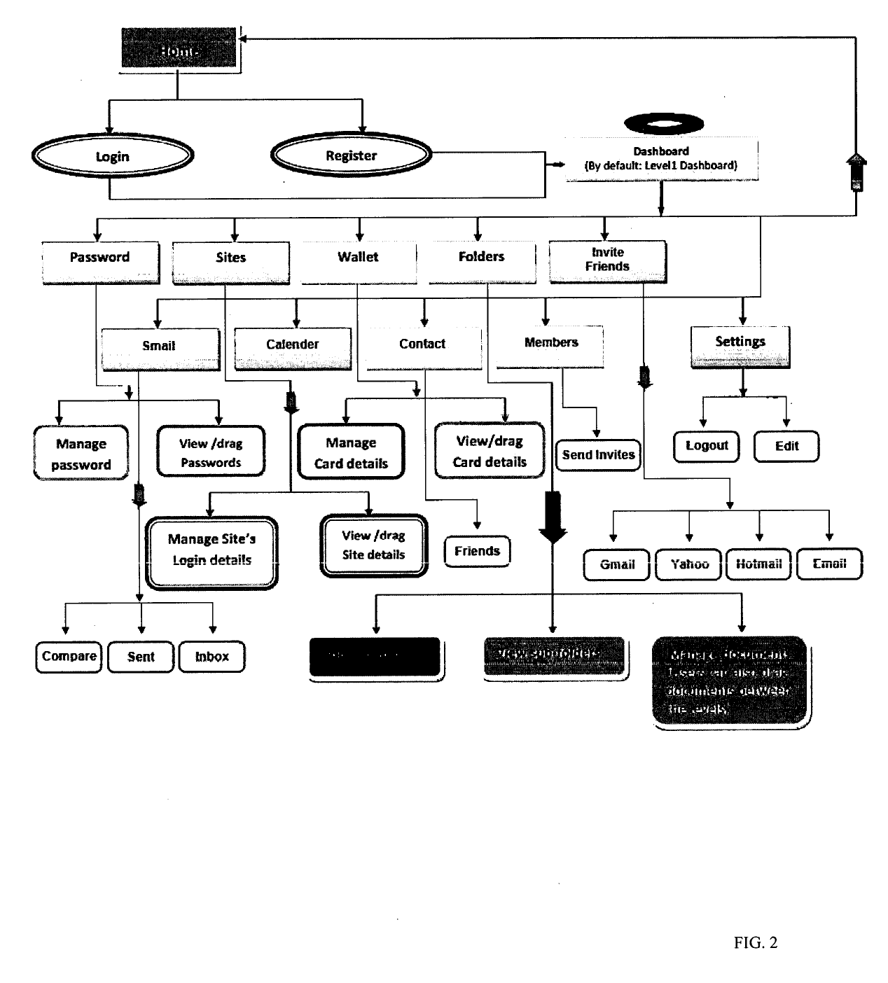

FIG. 2 is a diagrammatic representation of a dashboard functionality which grants the user an overview of all available functions on various security levels. In one embodiment, only security level one has a dashboard functionality. In another embodiment, each unique security level has its own dashboard functionality. In other embodiments, different dashboards with various functionality exist on different security levels. Dashboard functionality may be adjusted by the user.

In one embodiment, a management tool allows a user to configure and add other security levels. Said configuration includes, but is not limited to, the number of security levels and the authentication means associated with each security level. In another embodiment, each unique security level has is own management tool that allows the user to configure only the current security level and the authentication means associated therewith.

In an embodiment, a web-based uploading component is configured to upload the user's digital information to the secure webserver/remote database to be stored on a specific security level. Said security level is designated by the user.

Once a user successfully gains access to security level one (6) through the login component (3), the user can access the uploading component. The uploading component is configured to securely upload digital information to the secure webserver/remote database (5) and at the same time, to designate a user selectable security level for said digital information. Once the digital information is uploaded to the secure webserver/remote database (5), said digital information can only be accessed by the user after entering the authentication means associated with the designed security level. According to another embodiment, the uploading component allows a user to enter and/or upload to the secure webserver/remote database, the user's information, files and/or a plurality of username and password pairs associated with specific websites.

In an embodiment the instant system and method includes a web-based digital communication component. The communication component may be comprised of instant messaging and email communications. The digital communication component may utilize peer-to-peer or client-server architecture. In another embodiment, the digital communication component utilizes any suitable digital communications architecture or programming language known to one skilled in the art. By utilizing the communication component a user can send digital communications to, and receive digital communications from, another user which is assigned a designated security level. Upon receipt of a digital communication from the sending user, the receiving user can only read and/or open the sent message/file if the receiving user enters the information necessary to satisfy the authentication means associated with the security level assigned to the message by the sending user. The communications component may also be capable of sending and receiving digital communications from like security levels to another, e.g. from one user's security level three to another user's security level three or the like. The communications component may also be configured to automatically set a default security level based upon a specific designated email address, username or the like, both for outgoing and incoming digital communications.

Communication between all web-based components and the secure webserver/remote database is protected by any known security technology/protocol known in the art, including, but not limited to SSL, Advanced Encryption Standard (AES), or any other encryption standard. In one embodiment 128 bit or 256 bit encryption is used.

In one embodiment, the registration component (2) and/or login (3) component are accessible directly from the website currently being viewed by the user without website redirection and without the use of associated software, mobile applications and/or browser extensions.

In one embodiment, a user is provided access to the secure webserver/remote database without the use of associated locally loaded software, mobile applications and/or browser extensions. In another embodiment, the user is provided access to the web-based registration, login, uploading and communication components without the use of associated locally loaded software, mobile applications and/or browser extensions.

In another embodiment, the security levels could be equal but different such that access to any level requires that level's authentication means but does not include access to any other security level. Alternatively, direct access to any higher security level could be possible via the entry of the information necessary to satisfy each and every authentication means assigned to each lower security level.

In one embodiment, a direct access component is contemplated. According to the direct access component, a user can access the login component and/or a specific security level directly from a website that is being viewed by the user. A user may also have direct access to specific login information associated with the currently viewed website, including but not limited to a username and password pair. Direct access may be accomplished by clicking on a web-based button that allows the user to access the login component and/or specific security level via a pop-up window displayed within the user's web browser without leaving the website the user is then viewing. The web based button may also give a user direct access to the user's specific login information associated with the currently viewed website. The web-based button may function via one of the following programming languages: JavaScript, JQuery, Flash, Java, C++, Objective-C, C, Scala, HTML, ASP.NET, Ruby on Rails, Python or PHP, as well as any programming language known to one in the art.

### EXAMPLES

A new user of the system and method disclosed herein is desirous of remotely and securely storing his: (a) social media username/password pair; (b) banking institution website's username/password pair; (c) charge card information; and (d) a scanned image (in .pdf) of his passport. The user would first engage the registration component via any internet connected device, including but not limited to a computer, mobile telephone or tablet through a web browser. Via the registration component (2), the user would be supplied with a master account login comprised of one authentication means and the information necessary to satisfy the authentication means. The user would then proceed to the login component (3) and enter the information, supplied by the registration component, necessary to satisfy said master account login authentication means (4). Upon successfully supplying the correct information to the login component (3), the user would encounter security level one (6). At this juncture, the user has the option to store some or all of his digital information on level one (6) via the uploading component. If the user is desirous of storing some or all of his digital information on a higher security level, the user can create any number of higher security levels and the associated authentication means for each level via the management tool.

In this example, the user chooses to create four security levels via the management tool, each security level requiring a unique authentication means. The user has decided that his social media username/password pair needs the lowest level of security and thus, decides to store this information on security level one (6). The user has also decided that the username/password pair for his banking institution's website needs additional security, and thus uploads this information to security level two (8). The user uploads his charge card information to security level three (10) and the scanned image of his passport to security level four (12), the highest level of security in this example. The user then logs off.

Several days later, the user forgets his social media username/password pair. The user can now access the login component (3) via any web connected device via a web browser and enter the information necessary to satisfy the master account login authentication means (4). Upon successful login, the user will have access to security level one (6) and can retrieve his social media username/password pair. The user will not have access to any information on security levels two through four (8, 10 and 12) without satisfying each authentication means associated with those levels (7, 9 and 11).

Later that same day, the user wishes to log in to his banking institution's website and does not remember his username/password pair. In order to view this information, the user can access security level one (6) as noted above, and then enter the additional information necessary to satisfy the security level two authentication means (7), said authentication means set previously by the user via the management tool. Upon successfully gaining access to security level two (8), the user has access to all information stored on security levels one (6) and two (8). If the user wishes to view his charge card information stored on security level three (10) from level two (8), he would have to enter the additional information necessary to satisfy the security level three authentication means (9), said authentication means set previously by the user via the management tool. Upon successfully gaining access to security level three (10), the user has access to all information stored on security levels one (6), two (8) and three (10). Finally, if the user wishes to view his scanned passport stored on security level four (12) from level three (10), he would have to enter the additional information necessary to satisfy the security level four authentication means (11), said authentication means set previously by the user via the management tool. Upon successfully gaining access to security level four (12), the user would have access to all information stored on security levels one (6), two (8), three (10) and four (12).

In another example, the same user, who has configured four security levels via the management tool, wishes to send a secure email to another user and thus engages the communication component. The communication component then asks the user to assign the email message a security level. In this instance, the user assigns the email security level three and send the email to the other user. The recipient user will be notified that he has received an email message upon gaining access to his security level one, but cannot open and/or read the email until he has provided all the additional information necessary to satisfy the security authentication means for his security levels two and three.

Each and every feature described herein, and each and every combination of two or more of such features, is included within the scope of the present invention provided that the features included in such a combination are not mutually exclusive.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

What is claimed is:

1. A computer implemented system comprising a memory stored therein, computer executable components and a processor that executes the following computer executable components:
a registration component that enables a user to create a master account on a secure webserver, the master account comprising one authentication means;
a login component that enables a user to securely access the secure webserver from a web browser by entering the information necessary to satisfy the master account authentication means;
a multilevel security component configured to store digital information on the secure web server, said security component adapted to store digital information on a plurality of distinct security levels, each distinct security level requiring its own unique authentication means for access; and
an uploading component configured to securely upload digital information to a specific security level on the secure webserver.

2. The system of claim 1, further comprising a management component configured to create distinct security levels on the secure webserver and to set the authentication means associated with each said security level.

3. The system of claim 1 wherein the authentication means is a username and password pair.

4. The system of claim 2 wherein the authentication means is a username and password pair.

5. The system of claim 1 wherein the authentication means are user selectable.

6. The system of claim 2 wherein the authentication means are user selectable.

7. The system of claim 1, wherein the registration component, login component, management component and uploading components are web based.

8. The system of claim 1 further comprising a communication component.

9. The system of claim 8 wherein the communication component is configured to assign digital communications designated security levels.

10. The system of claim 9 wherein the digital communications are comprised of emails and instant messages.

11. The system of claim 9 wherein the communication component is web based.

12. The system of claim 9 wherein the communication component utilizes client-server architecture.

13. The system of claim 1 further comprising a direct access component, said direct access component configured to provide direct access to digital information stored on the secure webserver from a currently view website.

14. The system of claim 1 further comprising a direct access component, said direct access component configured to provide direct access to a specific security level on the secure webserver from a currently viewed website.

15. The system of claim 13, the direct access component further comprising:
a web-based button located on a displayed website, said button proving direct access to specific information stored on the secure webserver without redirection from the displayed website.

16. The system of claim 14, the direct access component further comprising:
a web-based button located on a displayed website, said button proving direct access to a specific security level on the secure webserver without redirection from the displayed website.

17. A method of securely storing and accessing digital information comprising:
Creating a master account on a secure web server, the master account comprising one authentication means;
Accessing said secure web server by entering the information necessary to satisfy the master account authentication means;
Storing digital information on the secure web server on a plurality of distinct security levels, each distinct security level requiring its own unique authentication means for access;
Uploading digital information to a specific security level on the secure webserver;
Accessing the digital information stored on a specific security level on the secure webserver by entering the information necessary to satisfy the authentication means associated with the specific security level.

18. The method of claim 17 wherein the authentication means is a username and password pair.

19. The method of claim 17 further enabling a user to have direct access to the digital information stored on the secure webserver based upon a website currently viewed by the user.

20. The method of claim 17 further enabling a user to have direct access to a specific security level on the secure webserver based upon a website currently viewed by the user.
